(19) United States
(12) Patent Application Publication
(10) Pub. No.: US 2003/0045991 A1
(43) Pub. Date: Mar. 6, 2003

(54) Travel control system for vehicle

(76) Inventors: Akira Isogai, Anjo-shi (JP); Eiji Teramura, Okazaki-shi (JP); Takao Nishimura, Nagoya (JP); Hisanao Kato, Oobu-shi (JP); Norihiko Sakai, Anjo-shi (JP)

Correspondence Address: LAW OFFICES OF DAVID G. POSZ, 2000 L STREET, N.W., SUITE 200, WASHINGTON, DC, 20036, US

(21) Appl. No.: 10/223,219

(22) Filed: Aug. 20, 2002

(30) Foreign Application Priority Data
Aug. 31, 2001 (JP) 2001-264207

(51) Int. Cl. B60K 31/00

(52) U.S. Cl. 701/96; 701/301; 340/903; 180/170

(57) ABSTRACT

A travel control system for a subject vehicle includes a radar device for detecting preceding vehicles with respect to the subject vehicle. A controlling device operates for detecting, among the detected preceding vehicles, an interested preceding vehicle which immediately precedes the subject vehicle, and for accelerating and decelerating the subject vehicle in response to a condition of the interested preceding vehicle. A relative speed calculating device operates for calculating a relative speed between the subject vehicle and a next-lane preceding vehicle among the detected preceding vehicles. The next-lane preceding vehicle is a preceding vehicle in a lane next to a lane where the subject vehicle exists. The controlling device also operates for executing one of (1) suppression of acceleration of the subject vehicle and (2) deceleration control of the subject vehicle when the relative speed calculated by the relative speed calculating device is smaller than a prescribed negative value.

### BACKGROUND OF THE INVENTION

1. Field of the Invention

This invention relates to a travel control system for a vehicle such as an automotive vehicle. This invention also relates to a recording medium storing a computer program for travel control of a vehicle such as an automotive vehicle.

2. Description of the Related Art

A known vehicular travel control system measures the distance between a subject vehicle and a vehicle preceding the subject vehicle and also the relative speed therebetween, and accelerates or decelerates the subject vehicle in response to the measured distance and relative speed to maintain the measured distance at a desired inter-vehicle distance. When the preceding vehicle disappears, the known system accelerates the subject vehicle to a setting speed (a cruising speed) and then implements cruise control of the subject vehicle.

Generally, in the case where the subject vehicle moves considerably faster than vehicles moving along lanes adjacent to the lane of the subject vehicle, the driver of the subject vehicle considers a traffic jam to be occurring ahead of the subject vehicle. In such a case, the driver tends to be discomforted when the subject vehicle is accelerated or remains subjected to the cruise control by the known system.

Japanese patent application publication number 5-217099 discloses a vehicular travel control system which measures the distance between a subject vehicle and a vehicle preceding the subject vehicle and moving along the lane same as that of the subject vehicle, and also the distance between the subject vehicle and a vehicle preceding the subject vehicle and moving along a lane adjacent to the lane of the subject vehicle. The system detects the relative speed between the subject vehicle and the same-lane preceding vehicle, and the relative speed between the subject vehicle and the adjacent-lane preceding vehicle. The system decides whether or not the relative speed between the subject vehicle and the same-lane preceding vehicle and the relative speed between the subject vehicle and the adjacent-lane preceding vehicle remain substantially equal to each other for at least a prescribed time. In addition, the system decides whether or not the distance between the subject vehicle and the adjacent-lance preceding vehicle is longer than the distance between the subject vehicle and the same-lane preceding vehicle. In the case where the relative speed between the subject vehicle and the same-lane preceding vehicle and the relative speed between the subject vehicle and the adjacent-lane preceding vehicle remain substantially equal to each other for at least the prescribed time while the distance between the subject vehicle and the adjacent-lane preceding vehicle is equal to or shorter than the distance between the subject vehicle and the same-lane preceding vehicle, the system predicts that the adjacent-lane preceding vehicle will enter the lane of the subject vehicle. Thus, in such a case, the system closes a throttle actuator of the subject vehicle and thereby decelerates the subject vehicle to increase the distance to the same-lane preceding vehicle before the adjacent-lane preceding vehicle actually enters the lane of the subject vehicle.

Japanese patent number 2778327 (corresponding to Japanese patent application publication number 5-221252) relates to a vehicular travel control system including a radar device. The distances from a subject vehicle to vehicles preceding the subject vehicle are measured on the basis of detection signals generated by the radar device. Also, the relative speeds between the subject vehicle and the preceding vehicles are measured on the basis of the detection signals generated by the radar device. A mean distance among ones of the preceding vehicles which move in a lane adjacent to the lane of the subject vehicle is calculated on the basis of the measured relative speeds. A throttle of the subject vehicle is controlled in response to the calculated mean distance to increase or decrease the distance from the subject vehicle to a preceding vehicle moving in the lane same as that of the subject vehicle.

European patent application publication number 0605104 A1 corresponding to Japanese patent application publication number 6-219183 discloses a cruise control system including a forward looking distance sensor adapted to sense vehicles preceding an equipped vehicle (a subject vehicle) and moving in the same path as the equipped vehicle or in paths adjacent to the equipped vehicle. The system tracks the preceding vehicles, and controls braking or acceleration of the equipped vehicle in response to the preceding vehicles travelling in front of or on converging paths with the equipped vehicle in order to maintain a safe distance between the equipped vehicle and the preceding vehicles in or entering its path.

Japanese patent application publication number 10-205366 discloses a vehicular travel control system which detects the distances between a subject vehicle and vehicles preceding the subject vehicle. In addition, the system detects the relative speeds between the subject vehicle and the preceding vehicles. Furthermore, the system detects the angles of the preceding vehicles relative to the subject vehicle. The relative lateral speeds between the subject vehicle and the preceding vehicles are calculated from the detected angles of the preceding vehicles. One among the preceding vehicles which enters the lane of the subject vehicle from an adjacent lane is detected on the basis of the calculated relative lateral speeds. When a preceding vehicle entering the lane of the subject vehicle is detected, the speed of the subject vehicle is controlled in response to the distance, the relative speed, and the relative lateral speed between the subject vehicle and the preceding vehicle.

Japanese patent application publication number P2000-172998A discloses an inter-vehicle distance deciding system which includes a laser radar for detecting vehicles preceding a subject vehicle. The system counts the number of times a preceding vehicle has entered a region between the subject vehicle and an immediately preceding vehicle moving in the lane same as that of the subject vehicle. The system calculates the distance between preceding vehicles which move in a lane adjacent to the lane of the subject vehicle. In response to the counted number of times and the calculated distance between the preceding vehicles, a decision is made as to whether a traffic jam occurs. An optimal inter-vehicle distance for the subject vehicle is calculated on the basis of the result of the decision.

### SUMMARY OF THE INVENTION

It is a first object of this invention to provide an improved travel control system for a vehicle such as an automotive vehicle.

It is a second object of this invention to provide a recording medium storing a computer program for improved travel control of a vehicle such as an automotive vehicle.

A first aspect of this invention provides a travel control system for a subject vehicle. The system comprises a radar device for detecting preceding vehicles with respect to the subject vehicle; controlling means for detecting, among the preceding vehicles detected by the radar device, an interested preceding vehicle which immediately precedes the subject vehicle, and for accelerating and decelerating the subject vehicle in response to a condition of the interested preceding vehicle; and relative speed calculating means for calculating a relative speed between the subject vehicle and a next-lane preceding vehicle among the preceding vehicles detected by the radar device, the next-lane preceding vehicle being a preceding vehicle in a lane next to a lane where the subject vehicle exists; wherein the controlling means comprises means for executing one of (1) suppression of acceleration of the subject vehicle and (2) deceleration control of the subject vehicle when the relative speed calculated by the relative speed calculating means is smaller than a prescribed negative value.

A second aspect of this invention is based on the first aspect thereof, and provides a travel control system wherein the controlling means comprises means for executing one of (1) the suppression of acceleration of the subject vehicle and (2) the deceleration control of the subject vehicle in cases where the subject vehicle is in a traveling lane and the next-lane preceding vehicle is in a passing lane, and where the relative speed between the subject vehicle and the next-lane preceding vehicle is smaller than a first reference value.

A third aspect of this invention is based on the second aspect thereof, and provides a travel control system wherein the controlling means comprises means for executing one of (1) the suppression of acceleration of the subject vehicle and (2) the deceleration control of the subject vehicle in cases where the subject vehicle is in a passing lane and the next-lane preceding vehicle is in a traveling lane, and where the relative speed between the subject vehicle and the next-lane preceding vehicle is smaller than a second reference value which is less than the first reference value.

A fourth aspect of this invention is based on the first aspect thereof, and provides a travel control system further comprising curvature radius calculating means for calculating a radius of a curvature of a road along which the subject vehicle is traveling, wherein the controlling means comprises means for executing one of (1) the suppression of acceleration of the subject vehicle and (2) the deceleration control of the subject vehicle when the curvature radius calculated by the curvature radius calculating means is smaller than a predetermined value.

A fifth aspect of this invention is based on the first aspect thereof, and provides a travel control system wherein the controlling means comprises means for executing one of (1) the suppression of acceleration of the subject vehicle and (2) the deceleration control of the subject vehicle in cases where a lateral position of the next-lane preceding vehicle relative to the subject vehicle corresponds to smaller than a predetermined value.

A sixth aspect of this invention is based on the first aspect thereof, and provides a travel control system wherein the controlling means comprises means for, when the interested preceding vehicle is detected, inhibiting one of (1) the suppression of acceleration of the subject vehicle and (2) the deceleration control of the subject vehicle, and accelerating and decelerating the subject vehicle in response to the condition of the interested preceding vehicle.

A seventh aspect of this invention is based on the first aspect thereof, and provides a travel control system wherein the relative speed calculating means comprises means for calculating an average of relative speeds between the subject vehicle and next-lane preceding vehicles.

An eighth aspect of this invention provides a recording medium storing a program for controlling a computer operating as the controlling means and the relative speed calculating means in the travel control system of the first aspect of this invention.

A ninth aspect of this invention provides a vehicular travel control system comprising first means for automatically accelerating a first vehicle; second means for detecting a second vehicle preceding the first vehicle and being in a lane next to a lane where the first vehicle exists; third means for detecting whether or not a speed of the first vehicle is higher than a speed of the second vehicle by more than a given value; and fourth means for suppressing the automatically accelerating of the first vehicle by the first means when the third means detects that the speed of the first vehicle is higher than the speed of the second vehicle by more than the given value.

A tenth aspect of this invention provides a vehicular travel control system comprising first means for detecting a first vehicle preceding a second vehicle and being in a lane next to a lane where the second vehicle exists; second means for detecting whether or not a speed of the second vehicle is higher than a speed of the first vehicle by more than a given value; and third means for decelerating the second vehicle when the second means detects that the speed of the second vehicle is higher than the speed of the first vehicle by more than the given value.

### BRIEF DESCRIPTION OF THE DRAWINGS

FIG. 1 is a block diagram of a travel control system for a vehicle according to a first embodiment of this invention.

FIG. 2 is a flowchart of a segment of a control program for an inter-vehicle ECU in FIG. 1.

FIG. 3 is a flowchart of a first block in FIG. 2.

FIG. 4 is a flowchart of a second block in FIG. 2.

FIG. 5 is a diagram of a control map providing a relation among a desired acceleration, an inter-vehicle deviation ratio, and a filtering-resultant relative speed.

FIG. 6 is a flowchart of a block in FIG. 4.

FIG. 7 is a flowchart of a block in FIG. 6.

FIG. 8 is a diagram of a control map providing a relation between a guard value ATup1 and an average relative speed.

FIG. 9 is a flowchart of a third block in FIG. 2.

FIG. 10 is a flowchart of a block in FIG. 9.

FIG. 11 is a flowchart of another block in FIG. 9.

FIG. 12 is a flowchart of a fourth block in FIG. 2.

### DETAILED DESCRIPTION OF THE INVENTION

### First Embodiment

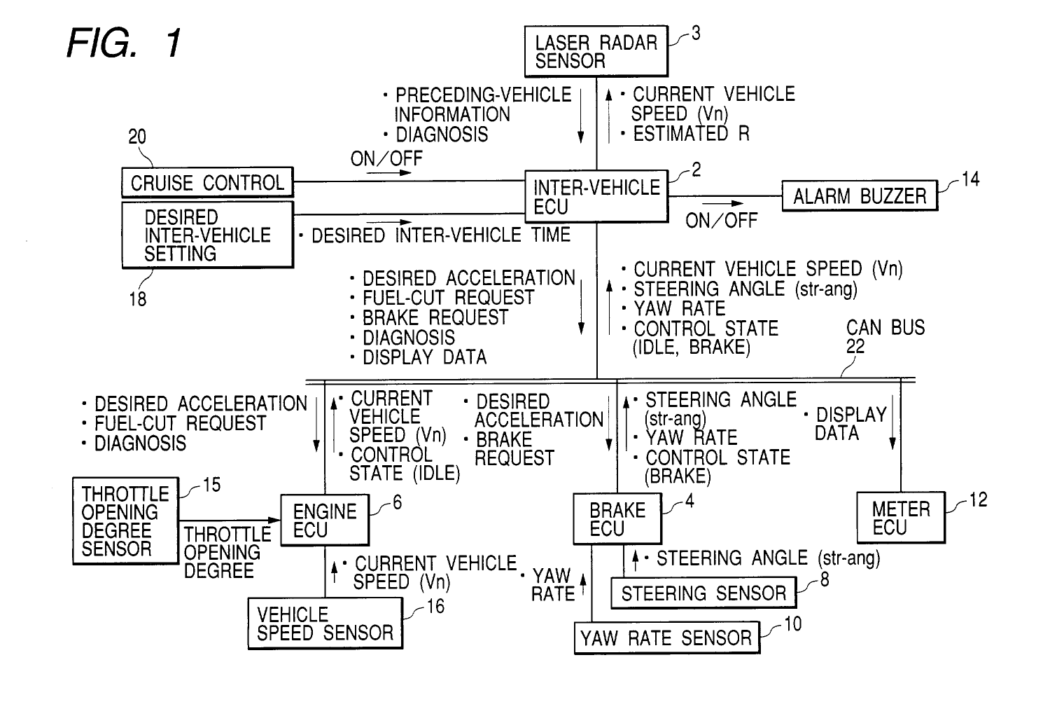

FIG. 1 shows a travel control system for a vehicle (a subject vehicle) according to a first embodiment of this invention. An example of the subject vehicle is an automotive vehicle. The subject vehicle is also referred to as the present vehicle. The system of FIG. 1 includes an inter-vehicle ECU (electronic control unit) 2, a brake ECU 4, an engine ECU 6, and a meter ECU 12 which are connected by a CAN bus 22. Signals are transmitted among the ECU's 2, 4, 6, and 12 via the CAN bus 22.

The inter-vehicle ECU 2 is formed by an electronic circuit including a microcomputer having a combination of an input/output port, a CPU, a ROM, and a RAM. The inter-vehicle ECU 2 operates in accordance with a control program stored in the ROM or the RAM.

Alternatively, the control program may be stored in a recording medium such as a floppy disk, a magneto-optical disk, a CD-ROM, a DVD-ROM, or a hard disk. In this case, the inter-vehicle ECU 2 is connected with a drive for the recording medium, and the control program is downloaded into the microcomputer of the inter-vehicle ECU 2 through the drive.

The inter-vehicle ECU 2 receives, from the engine ECU 6, a signal representing the current speed (Vn) of the subject vehicle (the present vehicle) and a control state signal related to idle control of the subject vehicle. The inter-vehicle ECU 2 receives, from the brake ECU 4, a signal representing the steering angle “stra-ng” of the subject vehicle, a signal representing the yaw rate of the subject vehicle, and a control state signal related to brake control of the subject vehicle.

A laser radar sensor 3 connected with the inter-vehicle ECU 2 includes a distance measurement device of a laser-based scanning type. The distance measurement device detects vehicles (objects) preceding the subject vehicle, and measures the distance from the subject vehicle to each of the detected preceding vehicles. The laser radar sensor 3 further includes a microcomputer programmed to process signals generated by the distance measurement device. The laser radar sensor 3 detects the lateral position of each detected preceding vehicle relative to the subject vehicle, and the speed of each detected preceding vehicle relative to the subject vehicle. Here, the lateral position is defined with respect to the center of the subject vehicle and along the widthwise direction of the subject vehicle. The laser radar sensor 3 sends a diagnosis signal to the inter-vehicle ECU 2.

The inter-vehicle ECU 2 passes the current vehicle speed (Vn) signal to the laser radar sensor 3. The inter-vehicle ECU 2 estimates the radius R of curvature of a road along which the subject vehicle is traveling. The inter-vehicle ECU 2 sends a signal representative of the estimated road curvature radius R to the laser radar sensor 3.

Preferably, the laser radar sensor 3 decides the center of the subject vehicle from the estimated road curvature radius R. The laser radar sensor 3 uses the decided center of the subject vehicle in detecting the lateral position of each detected preceding vehicle.

The laser radar sensor 3 computes the probability (the lane-sameness probability) P that the lanes along which the subject vehicle and each detected preceding vehicle (or each detected object) are traveling respectively are the same on the basis of various factors including the estimated road curvature radius R, the current speed Vn of the subject vehicle, and the lateral position of the preceding vehicle. Furthermore, the laser radar sensor 3 decides whether each detected preceding vehicle is stationary or moving.

The laser radar sensor 3 generates preceding-vehicle information. The laser radar sensor 3 sends the generated preceding-vehicle information to the inter-vehicle ECU 2. The preceding-vehicle information contains a signal representing the distance from the subject vehicle to each detected preceding vehicle, a signal representing the lateral position of each detected preceding vehicle relative to the subject vehicle, a signal representing the speed of each detected preceding vehicle relative to the subject vehicle, a signal representing the lane-sameness probability P for each detected preceding vehicle, and a signal representing whether each detected preceding vehicle is stationary or moving.

The distance measurement device in the laser radar sensor 3 has a transmitting and receiving portion, and a distance and angle calculating portion. The transmitting and receiving portion emits a forward laser beam ahead of the subject vehicle, and controls the forward laser beam to periodically scan a given angular region in front of the subject vehicle. The given angular region corresponds to a given sectorial detection area monitored by the transmitting and receiving portion. The transmitting and receiving portion informs the distance and angle calculating portion of the current direction of the forward laser beam. In the case where an object such as a preceding vehicle exists in the detection area (the given angular region), the forward laser beam encounters the object before being at least partially reflected thereby. A portion of the reflected laser beam returns to the transmitting and receiving portion as an echo laser beam. The transmitting and receiving portion receives the echo laser beam, and converts the echo laser beam into a corresponding electric signal. The transmitting and receiving portion outputs the electric signal to the distance and angle calculating portion. The distance and angle calculating portion detects the angle (the angular position) “θ” of the object in response to the output signal from the transmitting and receiving portion and the current direction of the forward laser beam. The distance and angle calculating portion measures the time interval between the moment of the transmission of a forward laser beam and the moment of the reception of a related echo laser beam in response to the output signal from the transmitting and receiving portion. The distance and angle calculating portion detects the distance “r” to the object from the subject vehicle on the basis of the measured time interval. Thus, the distance and angle calculating portion generates information about the angle (the angular position) “θ” of the object and the distance “r” thereto.

The inter-vehicle ECU 2 decides or selects one among the detected preceding vehicles in response to the preceding-vehicle information (for example, the lane-sameness probabilities P represented by the preceding-vehicle information) as an interested preceding vehicle to be considered by inter-vehicle control of the subject vehicle. The inter-vehicle ECU 2 derives the conditions of the interested preceding vehicle from the preceding-vehicle information, and generates command signals in response to the derived conditions of the interested preceding vehicle. The generated command signals are designed to suitably adjust the distance between the subject vehicle and the interested preceding vehicle. For example, the distance between the subject vehicle and the interested preceding vehicle is controlled in a predetermined safe range. In the absence of an interested preceding vehicle, the command signals are designed to cruise the subject vehicle at a setting speed. The command signals include a desired acceleration signal, a fuel-cut request signal, and a brake request signal for accelerating or decelerating the subject vehicle. The command signals also include a diagnosis signal. The inter-vehicle ECU 2 sends the desired acceleration signal, the fuel-cut request signal, and the diagnosis signal to the engine ECU 6. The inter-vehicle ECU 2 sends the desired acceleration signal and the brake request signal to the brake ECU 4.

The inter-vehicle ECU 2 derives the relative speed of the interested preceding vehicle from the preceding-vehicle information. The inter-vehicle ECU 2 calculates the absolute speed of the interested preceding vehicle from the relative speed thereof and the current speed Vn of the subject vehicle. The inter-vehicle ECU 2 is connected with an alarm buzzer 14. The inter-vehicle ECU 2 decides whether or not an alarm should be given in connection with, for example, the positional relation of the subject vehicle with the interested preceding vehicle. The inter-vehicle ECU 2 sends a warning request signal to the alarm buzzer 14 when deciding that an alarm should be given. The inter-vehicle ECU 2 generates display data. The inter-vehicle ECU 2 sends the generated display data to the meter ECU 12.

A desired inter-vehicle setting switch 18 and a cruise control switch 20 are connected with the inter-vehicle ECU 2. The desired inter-vehicle setting switch 18 generates and outputs a signal representing a desired inter-vehicle time equal to a desired distance between the subject vehicle and an interested preceding vehicle which is divided by a vehicle speed (for example, the current speed Vn of the subject vehicle). The inter-vehicle ECU 2 receives the signal representative of the desired inter-vehicle time from the desired inter-vehicle setting switch 18. The cruise control switch 20 generates and outputs an ON/OFF signal for executing and suspending cruise control of the subject vehicle. The inter-vehicle ECU 2 receives the cruise-control ON/OFF signal from the cruise control switch 20.

The brake ECU 4 is formed by an electronic circuit including a microcomputer. The brake ECU 4 is connected with a steering angle sensor 8 for detecting the steering angle “str-ang” of the subject vehicle, and a yaw rate sensor 10 for detecting the yaw rate of the subject vehicle. The brake ECU 4 derives the steering angle “str-ang” of the subject vehicle from an output signal of the steering angle sensor 8. The brake ECU 4 derives the yaw rate of the subject vehicle from an output signal of the yaw rate sensor 10. The brake ECU 4 sends a signal representative of the steering angle “str-ang” and a signal representative of the yaw rate to the inter-vehicle ECU 2.

The brake ECU 4 is connected with vehicular brake actuators (not shown). The brake ECU 4 receives the command signals (the desired acceleration signal and the brake request signal) from the inter-vehicle ECU 2. The brake ECU 4 drives the brake actuators in response to the received command signals. Thereby, the brake ECU 4 controls hydraulic braking pressures and adjusts deceleration (braking) of the subject vehicle in response to the received command signals. The brake ECU 4 generates a control state signal related to brake control of the subject vehicle. The brake ECU 4 sends the brake-related control state signal to the inter-vehicle ECU 2.

The engine ECU 6 is formed by an electronic circuit including a microcomputer. The engine ECU 6 is connected with a throttle opening degree sensor 15 for detecting the degree of opening of a throttle valve in the subject vehicle or detecting the position of the throttle valve, and a vehicle speed sensor 16 for detecting the current speed (Vn) of the subject vehicle. The engine ECU 6 derives the throttle opening degree from an output signal of the throttle opening degree sensor 15. The engine ECU 6 derives the current vehicle speed Vn from an output signal of the vehicle speed sensor 16. The engine ECU 6 sends a signal representative of the current vehicle speed Vn to the inter-vehicle ECU 2. The engine ECU 6 generates an idle-related control state signal in response to the throttle opening degree. The engine ECU 6 sends the idle-related control state signal to the inter-vehicle ECU 2. The engine ECU 6 receives the desired acceleration signal, the fuel-cut request signal, and the diagnosis signal from the inter-vehicle ECU 2. The engine ECU 6 decides operating conditions of a vehicular engine (not shown) and the subject vehicle on the basis of the received signals, the output signal of the throttle opening degree sensor 15, and the output signal of the vehicle speed sensor 16. The engine ECU 6 drives a vehicular throttle actuator (not shown), a vehicular transmission (not shown), and fuel injectors (not shown) in response to the decided operating conditions of the vehicular engine and the subject vehicle. Thereby, the engine ECU 6 adjusts acceleration or deceleration of the subject vehicle and selectively implements fuel cut in response to the decided operating conditions of the vehicular engine and the subject vehicle.

The inter-vehicle ECU 2 corresponds to a controlling means. As previously mentioned, the inter-vehicle ECU 2 operates in accordance with a control program stored in its internal ROM or RAM.

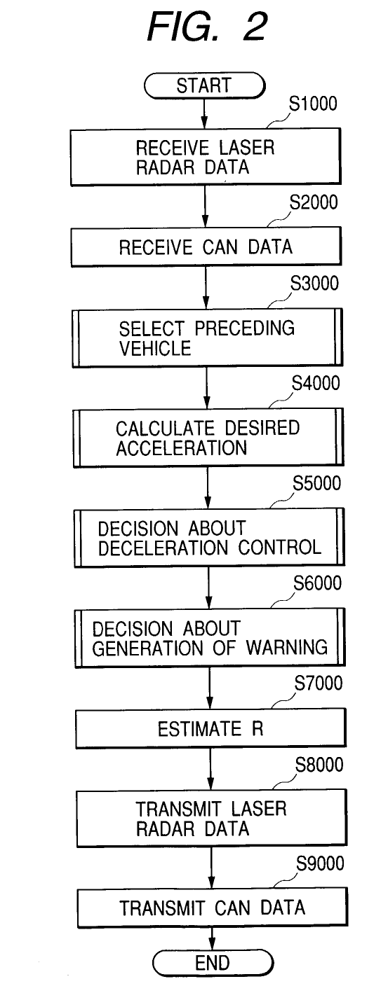

FIG. 2 is a flowchart of a main segment (a main routine) of the control program which is iteratively executed at a predetermined period. With reference to FIG. 2, a first step S1000 of the program segment receives laser radar data from the laser radar sensor 3. The laser radar data contain preceding-vehicle information. During the first execution cycle of the program segment, preceding-vehicle information sent from the laser radar sensor 3 to the inter-vehicle ECU 2 is not used in the inter-vehicle control since it is generated without considering an estimated road curvature radius R. During the second and later execution cycles of the program segment, preceding-vehicle information sent from the laser radar sensor 3 to the inter-vehicle ECU 2 is used in the inter-vehicle control.

A step S2000 following the step S1000 receives the signal of the current vehicle speed Vn and the idle-related control state signal from the engine ECU 6. The step S2000 receives the signal of the steering angle “str-ang”, the signal of the yaw rate, and the brake-related control state signal from the brake ECU 4.

A block S3000 subsequent to the step S2000 derives a group of candidate preceding vehicles from the laser radar data. The block S3000 decides or selects one among the candidate preceding vehicles as an interested preceding vehicle to be considered by the inter-vehicle control.

A block S4000 following the block S3000 calculates a desired acceleration of the subject vehicle for acceleration and deceleration control of the subject vehicle with respect to the interested preceding vehicle decided by the block S3000, and deceleration control of the subject vehicle or suppression of acceleration of the subject vehicle executed when there is a significant speed difference between the subject vehicle and a preceding vehicle moving in a lane adjacent or next to the lane of the subject vehicle.

A block S5000 subsequent to the block S4000 executes a judgment or decision about deceleration control of the subject vehicle on the basis of the desired acceleration calculated by the block S4000. Specifically, the block S5000 generates deceleration request signals in response to the desired acceleration. The deceleration request signals include the brake request signal and the fuel-cut request signal directed to the brake ECU 4 and the engine ECU 6.

A block S6000 following the block S5000 decides whether an alarm should be given.

A step S7000 subsequent to the block S6000 estimates the radius R of curvature of a road, along which the subject vehicle is traveling, from at least two of the current vehicle speed Vn, the steering angle “str-ang”, and the yaw rate.

A step S8000 following the step S7000 sends a signal of the estimated road curvature radius R and a signal of the current vehicle speed Vn to the laser radar sensor 3. The estimated road curvature radius R and the current vehicle speed Vn are used by the laser radar sensor 3 to generate preceding-vehicle information which will be received by the step S1000 during the next execution cycle of the program segment.

A step S9000 subsequent to the step S8000 sends the desired acceleration signal and the fuel-cut request signal to the engine ECU 6. The step S9000 sends the desired acceleration signal and the brake request signal to the brake ECU 4. Here, the desired acceleration signal means a signal representing the desired acceleration of the subject vehicle. After the step S9000, the current execution cycle of the program segment ends.

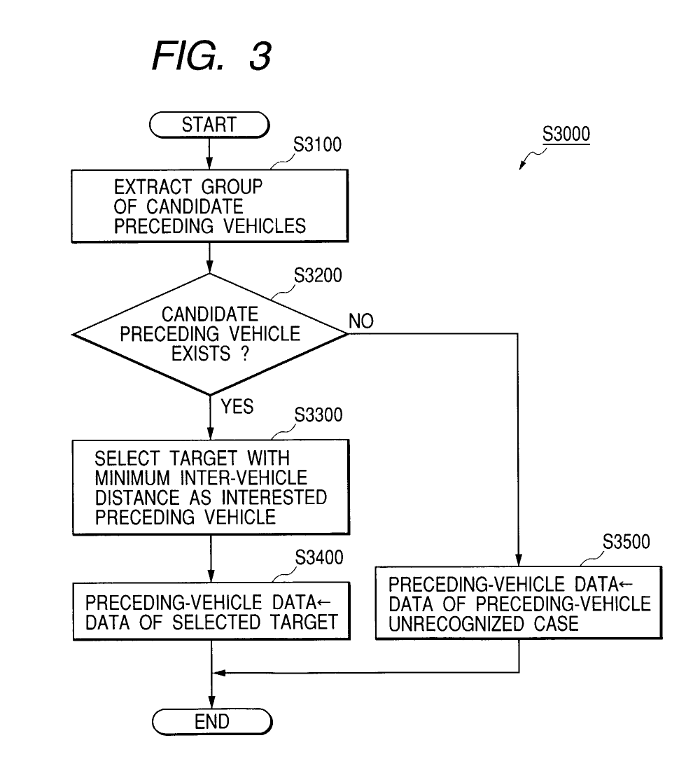

FIG. 3 shows the details of the block S3000 in FIG. 2. Objects detected by the laser radar sensor 3 are also referred to as targets. The targets include preceding vehicles. As shown in FIG. 3, the block S3000 has a step S3100 which immediately follows the step S2000 of FIG. 2.

The step S3100 derives a group of candidate preceding vehicles from the preceding-vehicle information outputted by the laser radar sensor 3. Specifically, the step S3100 refers to the preceding-vehicle information, and thereby finds targets having lane-sameness probabilities P higher than a predetermined threshold value. The step S3100 defines the found targets as candidate preceding vehicles.

A step S3200 following the step S3100 decides whether or not at least one candidate preceding vehicle has been given by the step S3100. When at least one candidate preceding vehicle has been given, the program advances from the step S3200 to a step S3300. Otherwise, the program advances from the step S3200 to a step S3500.

The step S3500 sets data representing the absence of an interested preceding vehicle from the detection area. After the step S3500, the program advances to the block S4000 in FIG. 2.

The step S3300 derives, from the preceding-vehicle information, the distances between the subject vehicle and the candidate preceding vehicles. The step S3300 compares the derived distances. The step S3300 uses the comparison results, and thereby selects one among the candidate preceding vehicles which is the closest to the subject vehicle, that is, which has the shortest distance to the subject vehicle. The step S3300 defines the selected preceding vehicle as an interested preceding vehicle to be considered by the inter-vehicle control. In the case where only one candidate preceding vehicle exists, the step S3300 designates the candidate preceding vehicle as an interested preceding vehicle.

A step S3400 following the step S3300 derives data about the interested preceding vehicle from the preceding-vehicle information. The derived data are referred to as the preceding vehicle data. After the step S3400, the program advances to the block S4000 in FIG. 2.

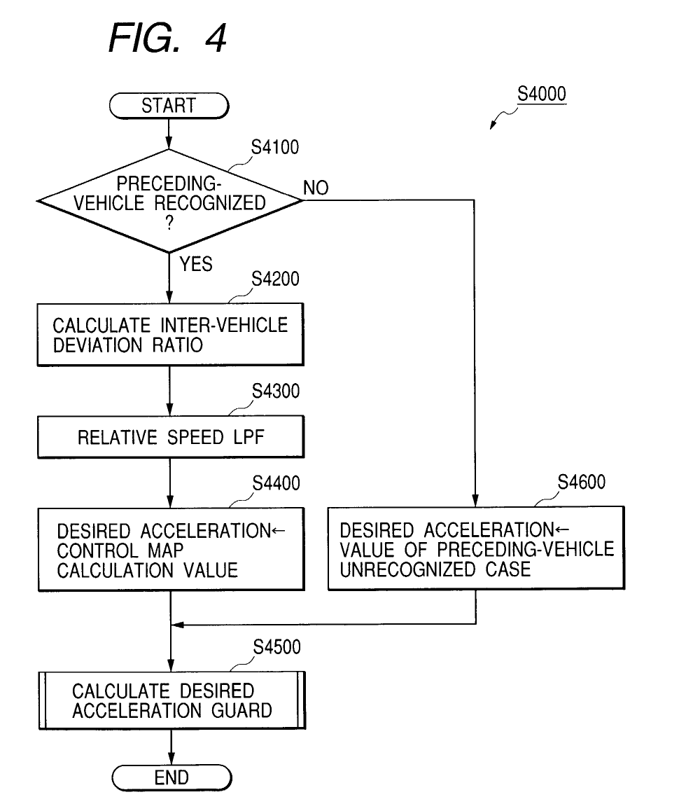

FIG. 4 shows the details of the block S4000 in FIG. 2. As shown in FIG. 4, the block S4000 has a step S4100 which immediately follows the block S3000 of FIG. 2.

The step S4100 decides whether or not an interested preceding vehicle is being recognized, that is, whether or not an interested preceding vehicle exists by referring to the results of the processing by the steps S3400 and S3500 in FIG. 3. When an interested preceding vehicle exists or when the step S3400 has provided preceding vehicle data, the program advances from the step S4100 to a step S4200. On the other hand, when an interested preceding vehicle does not exist or when the step S3500 has set data representing the absence of an interested preceding vehicle, the program advances from the step S4100 to a step S4600.

The step S4600 sets a desired acceleration of the subject vehicle to a predetermined value chosen in consideration of the absence of an interested preceding vehicle. After the step S4600, the program advances to a block S4500.

The step S4200 calculates an inter-vehicle deviation ratio (%). Specifically, the step S4200 subtracts a desired inter-vehicle distance from the current inter-vehicle distance, that is, the current distance between the subject vehicle and the interested preceding vehicle. The step S4200 divides the subtraction result by the desired inter-vehicle distance to get the inter-vehicle deviation ratio. Preferably, the desired inter-vehicle distance is equal to a predetermined value.

A step S4300 following the step S4200 derives the relative speed between the subject vehicle and the interested preceding vehicle from the preceding-vehicle information outputted by the laser radar sensor 3. The step S4300 subjects the derived relative speed to processing which corresponds to low-pass filtering for removing high-frequency noise components. Thus, the step S4300 gets the filtering-resultant relative speed between the subject vehicle and the interested preceding vehicle.

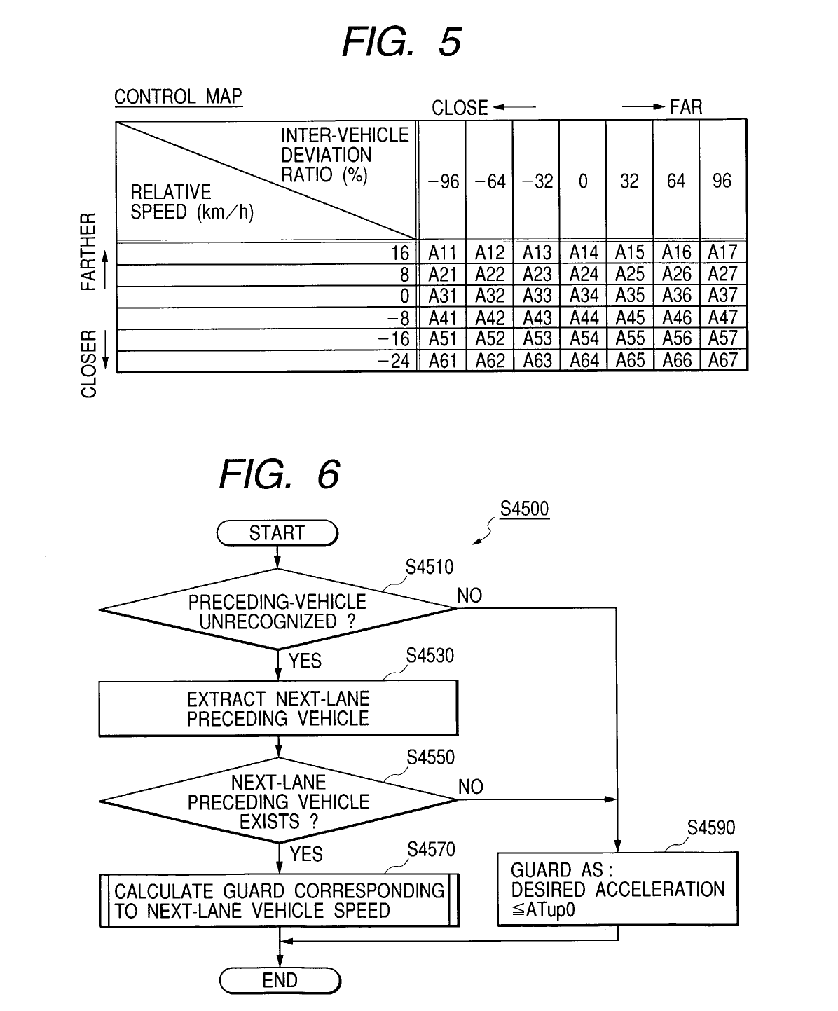

A step S4400 subsequent to the step S4300 calculates a desired acceleration of the subject vehicle from the inter-vehicle deviation ratio and the filtering-resultant relative speed by referring to a control map represented by data stored in the ROM or the RAM within the inter-vehicle ECU 2. As shown in FIG. 5, the control map contains desired acceleration values A11-A67 which are plotted as a function of the inter-vehicle deviation ratio and the filtering-resultant relative speed. The calculation of the desired acceleration is executed by selecting one among the values A11-A67 which corresponds to the inter-vehicle deviation ratio and the filtering-resultant relative speed. After the step S4400, the program advances to the block S4500.

The block S4500 executes a process of calculating a desired acceleration guard. After the block S4500, the program advances to the block S5000 in FIG. 2.

FIG. 6 shows the details of the block S4500 in FIG. 4. As shown in FIG. 6, the block S4500 has a step S4510 which immediately follows the step S4400 or S4600 of FIG. 4.

The step S4510 decides whether or not an interested preceding vehicle is being recognized. When an interested preceding vehicle is being recognized, the program advances from the step S4510 to a step S4590. On the other hand, when an interested preceding vehicle is not being recognized, the program advances from the step S4510 to a step S4530.

The step S4590 sets an upper limit of the desired acceleration to a predetermined guard value ATup0. In other words, the step S4590 guards the desired acceleration in accordance with the upper limit ATup0. Thus, the step S4590 limits the desired acceleration to the guard value ATup0 or less. The guard value ATup0 corresponds to the upper limit of a normally allowable desired acceleration range. This design is based on the fact that a driver of the subject vehicle tends to be less discomforted when an interested preceding vehicle is being recognized and the inter-vehicle control of the subject vehicle is implemented with respect to the interested preceding vehicle. After the step S4590, the program advances to the block S5000 in FIG. 2.

The step S4530 derives, from the preceding-vehicle information outputted by the laser radar sensor 3, preceding vehicles moving in lanes adjacent or next to the lane of the subject vehicle. Specifically, the step S4530 refers to the preceding-vehicle information, and thereby finds targets having lane-sameness probabilities P smaller than a prescribed value and being at lateral positions in a predetermined range (for example, 4 meters corresponding to the width of one lane) from the subject vehicle.

The predetermined range corresponds to smaller than a prescribed value “α” equal to 4 meters. The step S4530 defines the found targets as next-lane preceding vehicles, that is, preceding vehicles moving in the lane adjacent or next to the lane of the subject vehicle. Preferably, the lateral positions of the targets are defined with respect to the center of the subject vehicle which is decided on the basis of the estimated road curvature radius R.

A step S4550 following the step S4530 decides whether or not at least one next-lane preceding vehicle is derived by the step S4530. When at least one next-lane preceding vehicle is derived, the program advances from the step S4550 to a block S4570. Otherwise, the program advances from the step S4550 to the step S4590. As previously mentioned, the step S4590 sets the upper limit of the desired acceleration to the guard value ATup0. After the step S4590, the program advances to the block S5000 in FIG. 2.

The block S4570 executes a process of calculating a next-lane vehicle speed guard. After the block S4570, the program advances to the block S5000 of FIG. 2.

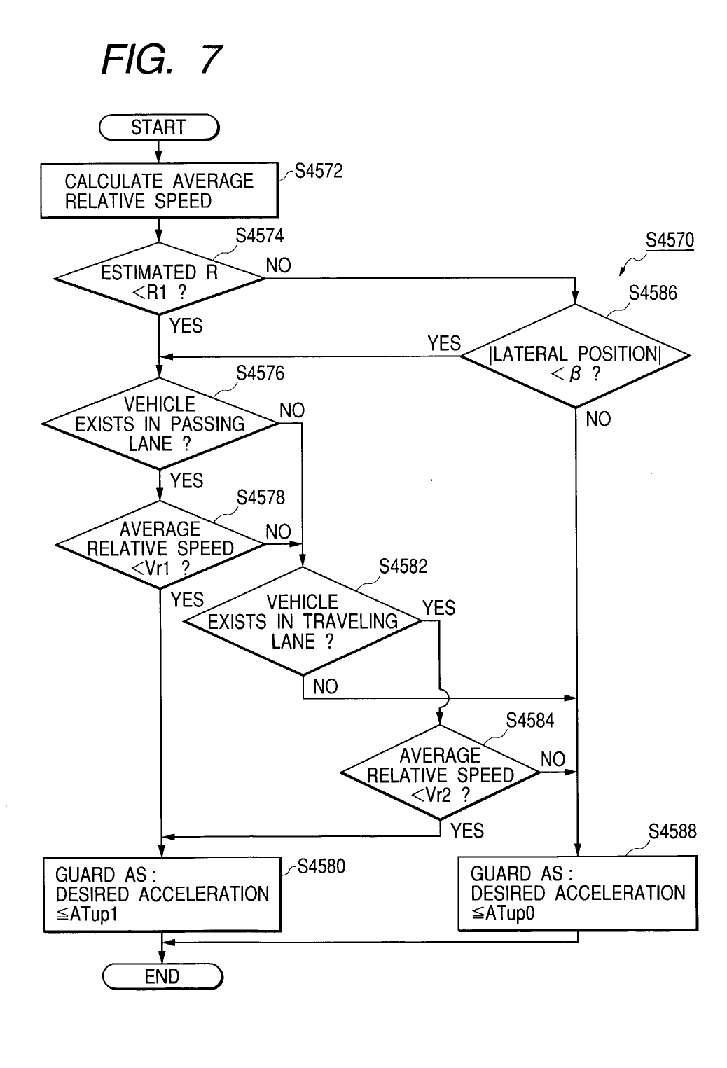

FIG. 7 shows the details of the block S4570 in FIG. 6. As shown in FIG. 7, the block S4570 has a step S4572 which immediately follows the step S4550 of FIG. 6.

The step S4572 derives the speeds of next-lane preceding vehicles relative to the subject vehicle from the preceding-vehicle information. Generally, the speeds of next-lane preceding vehicles relative to the subject vehicle are equal to the absolute speeds of the next-lane preceding vehicles minus the absolute speed of the subject vehicle. Therefore, the relative speeds of next-lane preceding vehicles are negative when the subject vehicle moves faster than the next-lane preceding vehicles. The step S4572 calculates the average (the mean) of the relative speeds of the next-lane preceding vehicles. The step S4572 corresponds to a relative speed calculating means. Specifically, under the condition that there are plural next-lane preceding vehicles, the step S4572 calculates the average (the mean) of the relative speeds of the next-lane preceding vehicles. When there is only one next-lane preceding vehicle, the step S4572 uses the relative speed of the next-lane preceding vehicle as an average (a mean). When there are preceding vehicles in each of the right-hand and left-hand lanes next to the lane of the subject vehicle, the step S4572 calculates the average (the mean) of the relative speeds of the next-lane preceding vehicles for each of the right-hand and left-hand next lanes.

A step S4574 following the step S4572 decides whether or not the estimated road curvature radius R is smaller than a prescribed value R1. The prescribed value R1 is chosen to correspond to the boundary between a sharp-curve range and a gentle-curve range. The prescribed value R1 is equal to, for example, 400 meters. When the estimated road curvature radius R is smaller than the prescribed value R1, the program advances from the step S4574 to a step S4576. Otherwise, the program advances from the step S4574 to a step S4586. The step S4574 corresponds to a curvature radius calculating means.

The step S4586 derives the lateral positions of the next-lane preceding vehicles relative to the subject vehicle from the preceding-vehicle information. The step S4586 decides whether or not at least one of the lateral positions of the next-lane preceding vehicles corresponds to smaller than a prescribed value “β”. This decision is to execute a process for preventing the driver of the subject vehicle from being discomforted when the lateral position of a next-lane preceding vehicle relative to the subject vehicle corresponds to a small value, that is, when the lateral spacing between the subject vehicle and a next-lane preceding vehicle is narrow. The prescribed value “β” is smaller than the prescribed value “α”. The prescribed value “β” is equal to, for example, 3 meters smaller than the width of one lane. When at least one of the lateral positions of the next-lane preceding vehicles corresponds to smaller than the prescribed value “β”, the program advances from the step S4586 to the step S4576. Otherwise, the program advances from the step S4586 to a step S4588.

The step S4588 sets an upper limit of the desired acceleration to the guard value ATup0. In other words, the step S4588 guards the desired acceleration in accordance with the upper limit ATup0. Thus, the step S4588 limits the desired acceleration to the guard value ATup0 or less. After the step S4588, the program advances to the block S5000 in FIG. 2.

The step S4576 decides whether or not at least one next-lane preceding vehicle exists in a passing lane. When at least one next-lane preceding vehicle exists in the passing lane, the program advances from the step S4576 to a step S4578. Otherwise, the program advances from the step S4576 to a step S4582. It should be noted that one of the right-hand and left-hand lanes next to the lane of the subject vehicle is generally defined as a passing lane according to the applied traffic rules. For example, when a next-lane preceding vehicle is in the left-hand side of the subject vehicle, it is decided that a next-lane preceding vehicle exists in a passing lane.

The step S4578 derives, from the results of the calculation by the step S4572, the average (the mean) of the relative speeds of preceding vehicles in the passing lane. The step S4578 decides whether or not the average of the relative speeds of the passing-lane preceding vehicles is smaller than a first reference value Vr1. The first reference value Vr1 is equal to a predetermined negative value. When the average relative speed is smaller than the first reference value Vr1, the program advances from the step S4578 to a step S4580. Otherwise, the program advances from the step S4578 to the step S4582.

The step S4580 sets the upper limit of the desired acceleration to a guard value ATup1. In other words, the step S4580 guards the desired acceleration in accordance with the upper limit ATup1. Thus, the step S4580 limits the desired acceleration to the guard value ATup1 or less. Preferably, the guard value ATup1 is equal to or less than the guard value ATup0. The processing by the step S4580 is to implement the following procedure. When a preceding vehicle in a passing lane is slower than the subject vehicle, a traffic jam may be occurring ahead of the subject vehicle. In such a case, the desired acceleration calculated by the step S4400 or S4600 is provided with a guard so as to execute suppression of acceleration of the subject vehicle or deceleration control of the subject vehicle. After the step S4580, the program advances to the block S5000 in FIG. 2.

Preferably, the step S4580 varies the guard value ATup1 as a function of the average relative speed given by the step S4578 or the average relative speed calculated by the step S4572. For example, a control map represented by data stored in the ROM or the RAM within the inter-vehicle ECU 2 provides a predetermined relation between the guard value ATup1 and the average relative speed. In this case, the step S4580 determines the guard value ATup1 in response to the average relative speed by referring to the control map. FIG. 8 shows an example of the control map. According to the control map in FIG. 8, the guard value ATup1 is equal to a predetermined minimum value when the average relative speed is equal to or lower than a specified speed Vr0. The guard value ATup1 is increased from the minimum value to a predetermined maximum value as the average relative speed rises from the specified speed Vr0 to the first reference value Vr1 (or a second reference value Vr2 indicated later). The guard value ATup1 is kept equal to the maximum value as the average relative speed rises from the first reference value Vr1 (or the second reference value Vr2). The maximum value of the guard value ATup1 is equal to the predetermined value ATup0 which corresponds to the upper limit of the normally allowable desired acceleration range. Accordingly, when the average relative speed is smaller than the first reference value Vr1 (or the second reference value Vr2), the desired acceleration calculated by the step S4400 or S4600 in FIG. 4 is strictly guarded or limited. On the other hand, when the average relative speed is equal to or higher than the first reference value Vr1 (or the second reference value Vr2), the desired acceleration is softly guarded or limited.

It should be noted that the guard value ATup1 may be varied as a function of the estimated road curvature radius R or the magnitude of the lateral position of a next-lane preceding vehicle closest to the subject vehicle.

With reference back to FIG. 7, the step S4582 decides whether or not a next-lane preceding vehicle exists in a traveling lane. When a next-lane preceding vehicle exists in the traveling lane, the program advances from the step S4582 to a step S4584. Otherwise, the program advances from the step S4582 to the step S4588 which limits the desired acceleration to the guard value ATup0 or less as previously mentioned. It should be noted that one of the right-hand and left-hand lanes next to the lane of the subject vehicle is generally defined as a traveling lane according to the applied traffic rules. For example, when a next-lane preceding vehicle is in the right-hand side of the subject vehicle, it is decided that a next-lane preceding vehicle exists in a traveling lane.

The step S4584 derives, from the results of the calculation by the step S4572, the average (the mean) of the relative speeds of preceding vehicles in the traveling lane. The step S4584 decides whether or not the average of the relative speeds of the traveling-lane preceding vehicles is smaller than a second reference value Vr2. The second reference value Vr2 is equal to a predetermined value. When the average relative speed is smaller than the second reference value Vr2, the program advances from the step S4584 to the step S4580 which limits the desired acceleration to the guard value ATup1 or less as previously mentioned. Otherwise, the program advances from the step S4584 to the step S4588 which limits the desired acceleration to the guard value ATup0 or less as previously mentioned. The step S4584 is provided in view of the following fact. In the case where the subject vehicle is moving along a passing lane, the driver of the subject vehicle tends to be discomforted when there is a great speed difference between the subject vehicle and a next-lane preceding vehicle in a traveling lane.

The second reference value Vr2 is set smaller than the first reference value Vr1 for the following reason. In the case where the subject vehicle in a traveling lane moves faster than a next-lane preceding vehicle in a passing lane, the driver of the subject vehicle sometimes considers a traffic jam to be occurring ahead of the subject vehicle and is hence discomforted even when the speed difference between the two vehicles is not so great. On the other hand, in the case where the subject vehicle is moving along a passing lane, it is normal that the subject vehicle moves faster than a next-lane preceding vehicle in a traveling lane. Therefore, in this case, the driver of the subject vehicle is hardly discomforted when the speed difference between the two vehicles is not great.

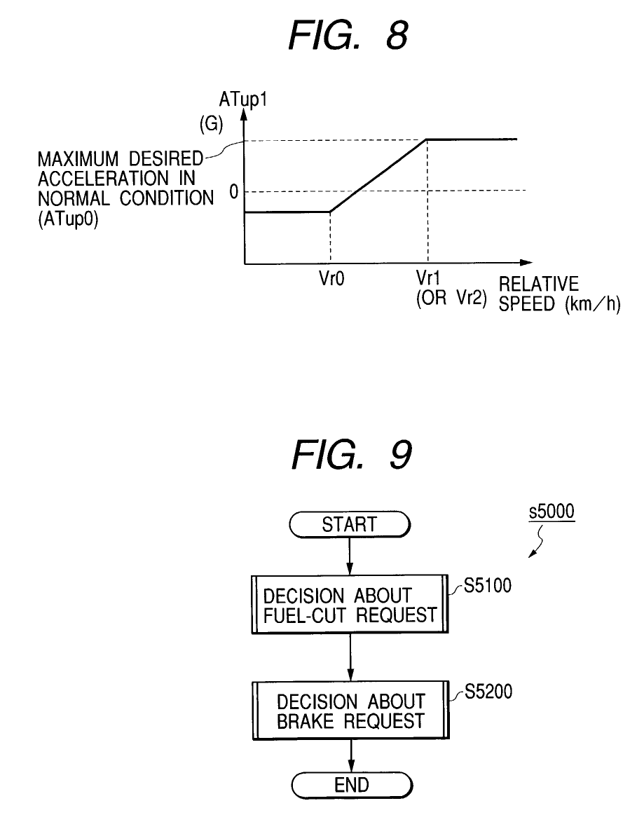

FIG. 9 shows the details of the block S5000 in FIG. 2. As shown in FIG. 9, the block S5000 has a block S5100 for a decision about a fuel-cut request which immediately follows the block S4000 of FIG. 2. The block S5100 is followed by a block S5200 for a decision about a brake request. The block S5200 is immediately followed by the block S6000 of FIG. 2.

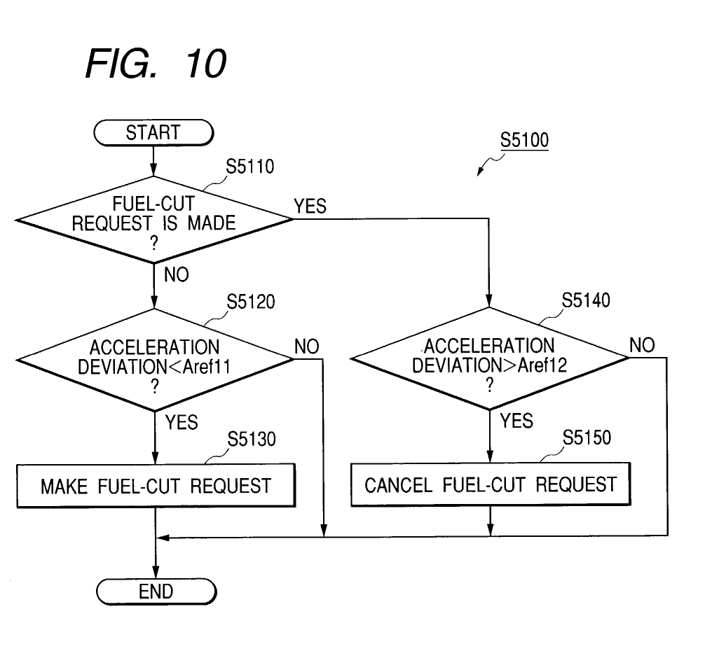

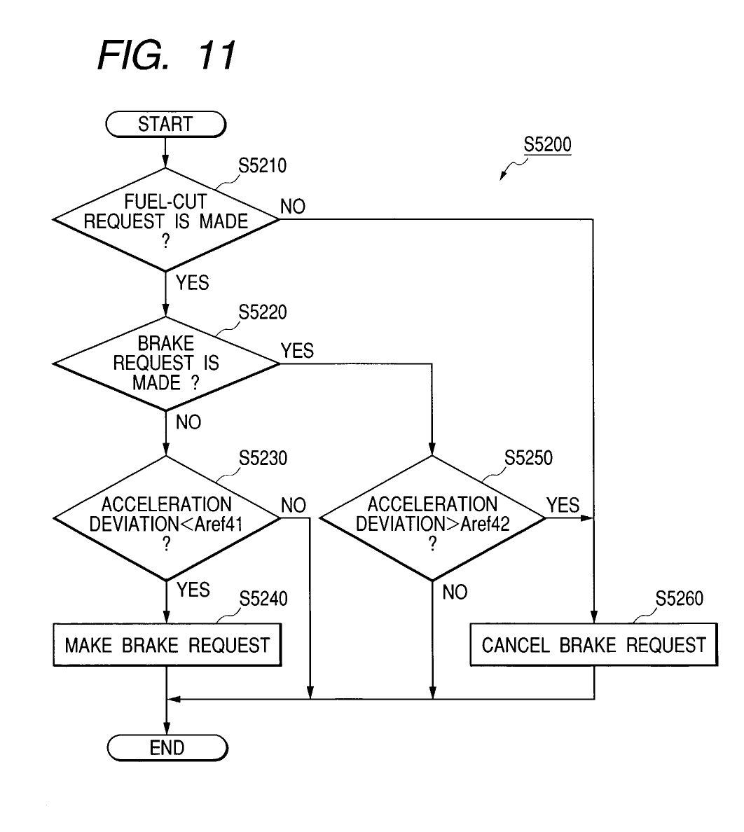

FIG. 10 shows the details of the block S5100 in FIG. 9. As shown in FIG. 10, the block S5100 has a step S5110 which immediately follows the block 40000 of FIG. 2.

The step S5110 decides whether or not a fuel-cut request is being made. When a fuel-cut request is being made, the program advances from the step S5110 to a step S5140. Otherwise, the program advances from the step S5110 to a step S5120.

The step S5120 derives an actual acceleration of the subject vehicle from, for example, a time-domain variation in the current vehicle speed Vn. The step S5120 subtracts the actual acceleration from the desired acceleration to get an acceleration deviation (an acceleration difference). The step S5120 decides whether or not the acceleration deviation is smaller than a reference value Aref11. The reference value Aref11 is equal to, for example, a predetermined value. When the acceleration deviation is smaller than the reference value Aref11, the program advances from the step S5120 to a step S5130. Otherwise, the program advances from the step S5120 to the block S5200 in FIG. 9.

The step 35130 makes a fuel-cut request. As a result, fuel cut is executed. After the step S5130, the program advances to the block S5200 in FIG. 9.

The steps S5120 and S5130 provide the following procedure. When the actual acceleration considerably deviates from the desired acceleration or when the actual acceleration is significantly greater than the desired acceleration so that the acceleration deviation is smaller than the reference value Aref11, the subject vehicle needs to be decelerated and thus fuel cut is executed.

The step S5140 derives an actual acceleration of the subject vehicle from, for example, a time-domain variation in the current vehicle speed Vn. The step S5140 subtracts the actual acceleration from the desired acceleration to get an acceleration deviation (an acceleration difference). The step S5140 decides whether or not the acceleration deviation is greater than a prescribed value Aref12. The prescribed value Aref12 is greater than the reference value Aref11. When the acceleration deviation is greater than the prescribed value Aref12, the program advances from the step S5140 to a step S5150. Otherwise, the program advances from the step S5140 to the block S5200 in FIG. 9.

The step S5150 cancels the fuel-cut request. As a result, the fuel cut is suspended. After the step S5150, the program advances to the block S5200 in FIG. 9.

The steps S5140 and S5150 provide the following procedure. When the actual acceleration sufficiently follows the desired acceleration or when the actual acceleration is smaller than the desired acceleration so that the acceleration deviation is greater than the prescribed value Aref12, the subject vehicle remains in an excessively decelerating state and thus fuel cut is canceled. On the other hand, when the acceleration deviation is equal to or less than the prescribed value Aref12, the fuel cut is continued.

FIG. 11 shows the details of the block S5200 in FIG. 9. As shown in FIG. 11, the block S5200 has a step S5210 which immediately follows the block 5100 of FIG. 9.

The step S5210 decides whether or not a fuel-cut request is being made. When a fuel-cut request is being made, the program advances from the step S5210 to a step S5220. Otherwise, the program advances from the step S5210 to a step S5260.

The step S5220 decides whether or not a brake request is being made. When a brake request is being made, the program advances from the step S5220 to a step S5250. Otherwise, the program advances from the step S5220 to a step S5230.

The step S5230 decides whether or not the acceleration deviation (calculated by the block S5100) is smaller than a reference value Aref41. The reference value Aref41 is equal to, for example, a predetermined value. When the acceleration deviation is smaller than the reference value Aref41, the program advances from the step S5230 to a step S5240. Otherwise, the program advances from the step S5230 to the block S6000 in FIG. 2.

The step S5240 makes a brake request. As a result, the braking of the subject vehicle is executed. After the step S5240, the program advances to the block S6000 in FIG. 2.

The steps S5230 and S5240 provide the following procedure. When the actual acceleration considerably deviates from the desired acceleration or when the actual acceleration is significantly greater than the desired acceleration so that the acceleration deviation is smaller than the reference value Aref41, the subject vehicle is required to be decelerated and thus the braking of the subject vehicle is executed.

The step S5250 decides whether or not the acceleration deviation (calculated by the block S5100) is greater than a prescribed value Aref42. The prescribed value Aref42 is greater than the reference value Aref41. When the acceleration deviation is greater than the prescribed value Aref42, the program advances from the step S5250 to the step S5260. Otherwise, the program advances from the step S5250 to the block S6000 in FIG. 2.

The step S5260 cancels the brake request. As a result, the braking of the subject vehicle is suspended. After the step S5260, the program advances to the block S6000 in FIG. 2.

The steps S5250 and S5260 provide the following procedure.

When the actual acceleration sufficiently follows the desired acceleration so that the acceleration deviation is greater than the prescribed value Aref42, the subject vehicle does not need to be further decelerated and thus the braking of the subject vehicle is canceled. On the other hand, when the acceleration deviation is equal to or less than the prescribed value Aref42, the braking of the subject vehicle is continued.

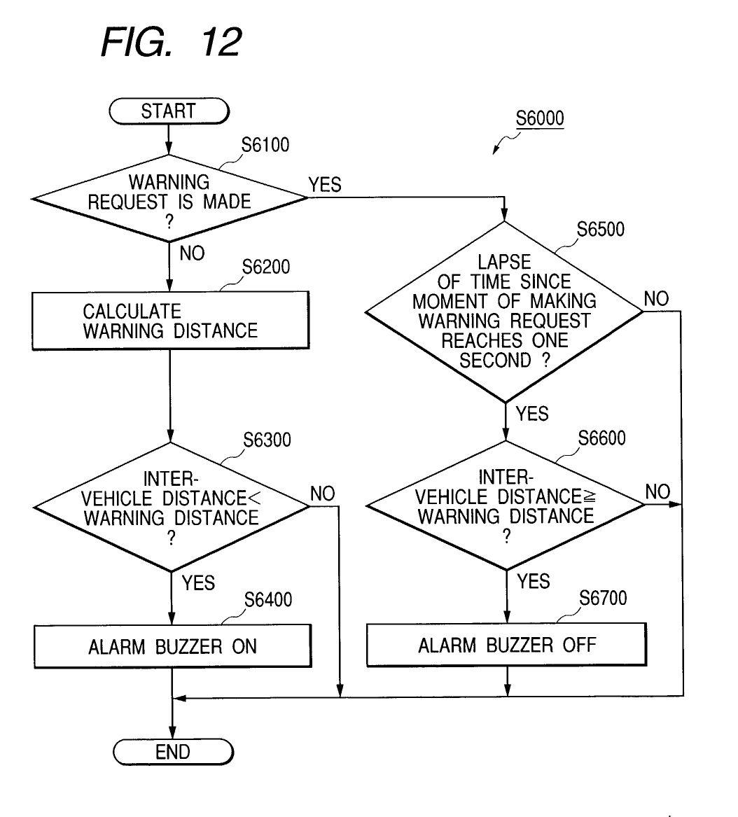

FIG. 12 shows the details of the block S6000 in FIG. 2. As shown in FIG. 12, the block S6000 has a step S6100 which immediately follows the block S5000 of FIG. 2.

The step S6100 decides whether or not a warning request is being made. When a warning request is being made, the program advances from the step S6100 to a step S6500. Otherwise, the program advances from the step S6100 to a step S6200.

The step S6200 calculates a warning threshold distance. After the step S6200, the program advances to a step S6300.

The step S6300 derives the distance between the subject vehicle and the interested preceding vehicle from the preceding vehicle information. The step S6300 decides whether or not the distance between the subject vehicle and the interested preceding vehicle is shorter than the warning threshold distance. When the distance between the subject vehicle and the interested preceding vehicle is shorter than the warning threshold distance, the program advances from the step S6300 to a step S6400. Otherwise, the program advances from the step S6300 to the step S7000 in FIG. 2.

The step S6400 makes a warning request. As a result, the alarm buzzer 14 is turned on. After the step S6400, the program advances to the step S7000 in FIG. 2.

The step S6500 decides whether or not the lapse of time since the moment of making the warning request reaches one second. When the lapse of time reaches one second, the program advances from the step S6500 to a step S6600. Otherwise, the program advances from the step S6500 to the step S7000 in FIG. 2.

The step S6600 derives the distance between the subject vehicle and the interested preceding vehicle from the preceding-vehicle information. The step S6600 compares the distance between the subject vehicle and the interested preceding vehicle with the warning threshold distance. When the distance between the subject vehicle and the interested preceding vehicle is equal to or longer than the warning threshold distance, the program advances from the step S6600 to a step S6700. Otherwise, the program advances from the step S6600 to the step S7000 in FIG. 2.

The step S6700 cancels the warning request. As a result, the alarm buzzer 14 is turned off. After the step S6700, the program advances to the step S7000 in FIG. 2.

As understood from the previous description, in the case where the estimated road curvature radius R is smaller than the prescribed value R1 and the average of the relative speeds of next-lane preceding vehicles in a passing lane is smaller than the first reference value Vr1, the suppression of acceleration of the subject vehicle or the deceleration control of the subject vehicle is implemented. Also, in the case where at least one of the lateral positions of next-lane preceding vehicles corresponds to smaller than the prescribed value “β” and the average of the relative speeds of next-lane preceding vehicles in a passing lane is smaller than the first reference value Vr1, the suppression of acceleration of the subject vehicle or the deceleration control of the subject vehicle is implemented. Therefore, in conditions where the subject vehicle is moving along a sharp curve or the lateral spacing between the subject vehicle and a next-lane preceding vehicle is narrow, it is possible to prevent the driver of the subject vehicle from being discomforted even when the relative speed of the next-lane preceding vehicle in a passing lane goes negative.

In the case where the subject vehicle is moving in a passing lane, the suppression of acceleration of the subject vehicle or the deceleration control of the subject vehicle is implemented under the following conditions. When the estimated road curvature radius R is smaller than the prescribed value R1 and the average of the relative speeds of next-lane preceding vehicles in a traveling lane is smaller than the second reference value Vr2, the suppression of acceleration of the subject vehicle or the deceleration control of the subject vehicle is implemented. Also, when at least one of the lateral positions of next-lane preceding vehicles corresponds to smaller than the prescribed value “β” and the average of the relative speeds of next-lane preceding vehicles in a traveling lane is smaller than the second reference value Vr2, the suppression of acceleration of the subject vehicle or the deceleration control of the subject vehicle is implemented. Therefore, even in the case where the relative speed of a next-lane preceding vehicle in a traveling lane is high, it is possible to prevent the driver of the subject vehicle from being discomforted.

### Second Embodiment

A second embodiment of this invention is similar to the first embodiment thereof except for design changes indicated hereafter. According to the second embodiment of this invention, when the average of the relative speeds of next-lane preceding vehicles in a passing lane is smaller than the first reference value Vr1 or when the average of the relative speeds of next-lane preceding vehicles in a traveling lane is smaller than the second reference value Vr2, the suppression of acceleration of the subject vehicle or the deceleration control of the subject vehicle is implemented regardless of the estimated road curvature radius R and the lateral spacing between the subject vehicle and each of the next-lane preceding vehicles.

### Third Embodiment

A third embodiment of this invention is similar to the first embodiment thereof except for design changes indicated hereafter. According to the third embodiment of this invention, when the subject vehicle is accelerating, the suppression of acceleration of the subject vehicle or the deceleration control of the subject vehicle may be implemented. When the subject vehicle is traveling at a cruise speed (a constant speed), the deceleration control of the subject vehicle may be implemented. When the subject vehicle is decelerating, the deceleration control of the subject vehicle may be implemented.

### Fourth Embodiment

A fourth embodiment of this invention is similar to the first embodiment thereof except for a design change indicated hereafter. According to the fourth embodiment of this invention, even in a preceding-vehicle-recognized state, the guard value ATup1 may be introduced to implement the suppression of acceleration of the subject vehicle or the deceleration control of the subject vehicle. This design is made in view of the following fact. Even in the case where a preceding vehicle is being recognized, when the preceding vehicle is traveling at a relatively high speed, it is considered that the subject vehicle is controlled to travel at a setting speed without following the preceding vehicle. In such a case, the driver of the subject vehicle tends to be discomforted when there is a significant speed difference between the subject vehicle and a next-lane preceding vehicle.

What is claimed is:

1. A travel control system for a subject vehicle, comprising:
a radar device for detecting preceding vehicles with respect to the subject vehicle;
controlling means for detecting, among the preceding vehicles detected by the radar device, an interested preceding vehicle which immediately precedes the subject vehicle, and for accelerating and decelerating the subject vehicle in response to a condition of the interested preceding vehicle; and
relative speed calculating means for calculating a relative speed between the subject vehicle and a next-lane preceding vehicle among the preceding vehicles detected by the radar device, the next-lane preceding vehicle being a preceding vehicle in a lane next to a lane where the subject vehicle exists;
wherein the controlling means comprises means for executing one of (1) suppression of acceleration of the subject vehicle and (2) deceleration control of the subject vehicle when the relative speed calculated by the relative speed calculating means is smaller than a prescribed negative value.

2. A travel control system as recited in claim 1, wherein the controlling means comprises means for executing one of (1) the suppression of acceleration of the subject vehicle and (2) the deceleration control of the subject vehicle in cases where the subject vehicle is in a traveling lane and the next-lane preceding vehicle is in a passing lane, and where the relative speed between the subject vehicle and the next-lane preceding vehicle is smaller than a first reference value.

3. A travel control system as recited in claim 2, wherein the controlling means comprises means for executing one of (1) the suppression of acceleration of the subject vehicle and (2) the deceleration control of the subject vehicle in cases where the subject vehicle is in a passing lane and the next-lane preceding vehicle is in a traveling lane, and where the relative speed between the subject vehicle and the next-lane preceding vehicle is smaller than a second reference value which is less than the first reference value.

4. A travel control system as recited in claim 1, further comprising curvature radius calculating means for calculating a radius of a curvature of a road along which the subject vehicle is traveling, wherein the controlling means comprises means for executing one of (1) the suppression of acceleration of the subject vehicle and (2) the deceleration control of the subject vehicle when the curvature radius calculated by the curvature radius calculating means is smaller than a predetermined value.

5. A travel control system as recited in claim 1, wherein the controlling means comprises means for executing one of (1) the suppression of acceleration of the subject vehicle and (2) the deceleration control of the subject vehicle in cases where a lateral position of the next-lane preceding vehicle relative to the subject vehicle corresponds to smaller than a predetermined value.

6. A travel control system as recited in claim 1, wherein the controlling means comprises means for, when the interested preceding vehicle is detected, inhibiting one of (1) the suppression of acceleration of the subject vehicle and (2) the deceleration control of the subject vehicle, and accelerating and decelerating the subject vehicle in response to the condition of the interested preceding vehicle.

7. A travel control system as recited in claim 1, wherein the relative speed calculating means comprises means for calculating an average of relative speeds between the subject vehicle and next-lane preceding vehicles.

8. A recording medium storing a program for controlling a computer operating as the controlling means and the relative speed calculating means in the travel control system of claim 1.

9. A vehicular travel control system comprising:
first means for automatically accelerating a first vehicle;
second means for detecting a second vehicle preceding the first vehicle and being in a lane next to a lane where the first vehicle exists;
third means for detecting whether or not a speed of the first vehicle is higher than a speed of the second vehicle by more than a given value; and
fourth means for suppressing the automatically accelerating of the first vehicle by the first means when the third means detects that the speed of the first vehicle is higher than the speed of the second vehicle by more than the given value.

10. A vehicular travel control system comprising:
first means for detecting a first vehicle preceding a second vehicle and being in a lane next to a lane where the second vehicle exists;
second means for detecting whether or not a speed of the second vehicle is higher than a speed of the first vehicle by more than a given value; and
third means for decelerating the second vehicle when the second means detects that the speed of the second vehicle is higher than the speed of the first vehicle by more than the given value.
